(19) United States
(12) Patent Application Publication
(10) Pub. No.: US 2022/0208429 A1
(43) Pub. Date: Jun. 30, 2022

(54) MAGNETIC CORE STRUCTURES

(71) Applicant: Resonant Link LLC, Shelburne, VT (US)

(72) Inventors: Charles Sullivan, West Lebanon, NH (US); Phyo Aung Kyaw, Winooski, VT (US); Aaron Stein, Essex, VT (US)

(21) Appl. No.: 17/547,812

(22) Filed: Dec. 10, 2021

Related U.S. Application Data
(63) Continuation of application No. PCT/US2021/016305, filed on Feb. 3, 2021.
(60) Provisional application No. 62/970,127, filed on Feb. 4, 2020.

(51) Int. Cl. H01F 17/04; H01F 3/10; H01F 27/28

(52) U.S. Cl. CPC H01F 17/043; H01F 2027/2857; H01F 27/2847; H01F 3/10

(57) ABSTRACT

A magnetic core may have one or more notches in a center post, backplate and/or outer rim. Such notches may reduce or eliminate dimensional resonance and/or reduce the amount of magnetic material. A magnetic core with or without notches may omit a backplate and/or an outer rim.

### RELATED APPLICATIONS

This application claims priority under 35 U.S.C. § 120 to and is a continuation of International Application No. PCT/US2021/016305, filed Feb. 3, 2021, which claims the benefit under 35 U.S.C. § 119(e) of the filing date of U.S. Provisional Application Ser. No. 62/970,127, filed Feb. 4, 2020, each of which is incorporated herein by reference.

### BACKGROUND

### 1. Technical Field

The apparatus and techniques described herein relate to magnetic core structures which may reduce or eliminate dimensional resonance and/or reduce the amount of magnetic material in the magnetic core. Such apparatus and techniques may find application in the field of wireless power transfer, for example.

### 2. Discussion of the Related Art

Magnetic cores used in various devices such as inductors and transformers to confine magnetic flux and store energy magnetically.

One application of magnetic cores is in wireless power transfer systems. A wireless power transfer system can transfer energy wirelessly through magnetic coupling. Various types of wireless power transfer systems exist, some examples of which are often referred to as inductive systems and resonant systems. A wireless power transfer system comprises wireless power transfer coils (also herein termed “coils” or “windings”) separated by some distance. These coils may include a loop or loops of conductors optionally placed in a magnetic core. A wireless power transmitter may include a transmit coil that may be coupled to a power source via power electronics. The power electronics may invert a DC (direct current) signal into an AC (alternating current) signal that can be transmitted wirelessly through electromagnetic induction. A wireless power receiver may include a receive coil and power electronics (e.g., a rectifier) that couples the receive coil to a load.

### SUMMARY

Some aspects relate to an apparatus, comprising: a magnetic core, comprising: a center post; an outer rim; and a backplate, having: a plurality of magnetic material members extending between the center post and the outer rim; and a plurality of notches having a width that increases with increased distance from the center post.

The center post may have at least one notch.

The outer rim may have at least one notch.

The center post may comprise a plurality of stacked pieces of magnetic material.

The outer rim may comprise a plurality of stacked pieces of magnetic material.

The center post may have the at least one notch extending through an entire thickness of the center post.

The outer rim may have the at least one notch extending through an entire thickness of the outer rim.

The notches in the stacked pieces of magnetic material of the center post or outer rim may be at different angular locations in different levels of magnetic material.

The plurality of notches of the backplate may be wedge-shaped.

The apparatus may further comprise a winding between the center post and the outer rim.

The winding may comprise a plurality of layers of foil conductors.

Some aspects relate to an apparatus, comprising: a magnetic core, comprising: one or more of A, B and/or C: A) a center post having at least one notch, termed at least one first notch; B) an outer rim having at least one notch, termed at least one second notch; and/or C) a backplate having at least one notch, termed at least one third notch.

The apparatus may comprise only A, only B, only C, two of A, B and C, or all of A, B and C.

The magnetic core may comprise A and the at least one first notch may extend entirely through a thickness of the center post, the magnetic core may comprise B and the at least one second notch may extend entirely through a thickness of the outer rim and/or the magnetic core may comprise C and the at least one third notch may extend entirely through a thickness of the backplate.

The at least one first, second and/or third notch, of which the magnetic core comprises, may comprise a plurality of segments at different circumferential positions, each of the plurality of segments extending partially through a core component, wherein the core component is the center post, outer rim or backplate.

The at least one first notch may be circumferentially aligned with or offset with respect to the at least one second notch and/or the at least one third notch.

The center post, outer rim and/or backplate individually may be a core component formed of a plurality of pieces of magnetic material.

Each of the plurality of pieces of magnetic material for a core component may have a same shape or a different shape, wherein the core component is the center post, outer rim or backplate.

The at least one first, second and/or third notch may be formed by a volume of reduced magnetic permeability and/or permittivity with respect to an adjacent region of the center post, outer rim and/or backplate or the at least one first, second and/or third notch may be formed by an interface between a plurality of pieces of magnetic material brought into contact with one another.

The at least one third notch may comprise a plurality of third notches individually having a wedge shape that is wider with increasing distance from a center of the magnetic core.

The apparatus may further comprise a winding magnetically coupled to the magnetic core.

Some aspects relate to an apparatus comprising: a magnetic core, comprising: two or more of A, B and C: A) a center post; B) an outer rim; and/or C) a backplate connecting the center post and the outer rim, wherein one or more notches are formed in two or more of the center post, outer rim and backplate, wherein when the magnetic core comprises an outer rim, a backplate and a center post, the center post not including a notch, a number of notches in the outer rim is different from two or a number of notches in the backplate is different from two.

Notches may be formed in the outer rim and the backplate.

The notches may extend entirely through a thickness of two or more of the center post, outer rim and backplate.

The notches may comprise a plurality of segments at different circumferential positions, each of the plurality of segments extending partially through a core component, wherein the core component is the center post, outer rim or backplate.

At least one first notch may be circumferentially aligned with or offset with respect to the at least one second notch and/or the at least one third notch.

The center post, outer rim and/or backplate may be formed of a plurality of pieces of magnetic material.

Each of the plurality of pieces of magnetic material for a core component may have a same shape or a different shape, wherein the core component is the center post, outer rim or backplate.

The notches may be formed by a volume of reduced magnetic permeability and/or permittivity with respect to an adjacent region of the center post, outer rim and/or backplate or the notches may be formed by an interface between a plurality of pieces of magnetic material brought into contact with one another.

The notches may comprise a plurality of notches individually having a wedge shape that is wider with increasing distance from a center of the magnetic core.

The magnetic core may comprise a ferromagnetic material.

Some aspects relate to an apparatus, comprising: a magnetic core, comprising: one or more of A and/or B: A) a center post; and/or B) an outer rim, wherein the magnetic core does not include a backplate.

One or more notches may be formed in the center post and/or the outer rim.

The notches may extend entirely through a thickness of the center post and/or the outer rim.

The notches may comprise a plurality of segments at different circumferential positions, each of the plurality of segments extending partially through a core component, wherein the core component is the center post or outer rim.

At least one first notch may be circumferentially aligned with or offset with respect to the at least one second notch.

The center post and/or outer rim may be formed of a plurality of pieces of magnetic material.

Each of the plurality of pieces of magnetic material for a core component may have a same shape or a different shape, wherein the core component is the center post, or outer rim.

The notches may be formed by a volume of reduced magnetic permeability and/or permittivity with respect to an adjacent region of the center post, and/or outer rim or the notches may be formed by an interface between a plurality of pieces of magnetic material brought into contact with one another.

The magnetic core may comprise a ferromagnetic material.

The center post may have a hole.

A number of notches in the backplate may be different from two and/or a number of notches in the outer rim is different from two.

Some aspects relate to a magnetic core, comprising: one or more of A, B and C: A) a center post having at least one first notch; B) an outer rim; and/or C) a backplate connecting the center post and the outer rim, wherein the outer rim has at least one second notch, the backplate has at least one third notch, or the outer rim has at least one second notch and the backplate has at least one third notch.

Some aspects relate to a magnetic core, comprising: two or more of A, B and C: A) a center post; B) an outer rim; and/or C) a backplate connecting the center post and the outer rim, wherein one or more notches are formed in two or more of the center post, outer rim and backplate, wherein when the magnetic core comprises an outer rim, a backplate and a center post, the center post not including a notch, a number of notches in the outer rim is different from two or a number of notches in the backplate is different from two.

Some aspects relate to a method of making or using the apparatus of any preceding paragraph or any apparatus described herein.

The foregoing summary is provided by way of illustration and is not intended to be limiting.

### BRIEF DESCRIPTION OF DRAWINGS

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein.

FIG. 1A shows an example of a winding including layers of coil conductors in a pot core. FIG. 1B shows an exploded view illustrating the layers of the foil winding, which is a multilayer conductor with integrated capacitor structure having alternating conductors separated by respective dielectric layers, according to some embodiments.

FIGS. 2A-2C show three views of a pot core illustrating the center post, backplate and outer rim, according to some embodiments.

FIGS. 3A-3E show various magnetic core shapes with the center post, backplate and outer rim labeled, according to some embodiments.

FIG. 4A shows an example with aligned notches in the center post, backplate and outer rim, according to some embodiments. FIG. 4B shows an example with unaligned notches, according to some embodiments.

FIG. 5A shows an example with a plurality of unaligned notches in the center post, backplate and outer rim, according to some embodiments. FIG. 5B shows an example with a plurality of aligned notches, according to some embodiments.

FIGS. 6A and 6B show a perspective view and a top view, respectively of a magnetic core with a wagon wheel design, according to some embodiments. FIG. 6C shows a perspective view of a core having a wagon wheel design where the notches in the outer rim are at different angular locations in different layers of core material, according to some embodiments.

FIGS. 7A-7D show examples of magnetic cores without a backplate, with and without an outer rim, according to some embodiments.

### DETAILED DESCRIPTION

Many wireless charging applications call for physically large coils resulting in large magnetic cores, which can be problematic. Large magnetic cores are heavy and expensive. Additionally, they can suffer from dimensional resonance, in which the relatively high permeability and permittivity of magnetic core material results in standing electromagnetic waves perpendicular to the flux path. These standing waves reduce performance by causing power loss (dimensional resonance loss) and reducing energy storage (the energy stored in inductance).

The inventors have developed shapes for magnetic cores that can reduce or eliminate dimensional resonance and/or can reduce the mass of magnetic material. Adding one or more notches to the center post, backplate, and/or outer rim of a core shape (e.g., a pot core) reduces or eliminates the impact of dimensional resonance in magnetic cores as it eliminates the standing electromagnetic wave. Furthermore, the notches can be used to reduce the mass of magnetic material. These “notches” can be any size or shape that creates a break in the magnetic core material, which may include a volume without magnetic material or an interface between adjacent contacting pieces of magnetic material where two separate pieces of magnetic material contact one another. An interface may have surface roughness that produces a microscopic discontinuity in the magnetic material, which can prevent dimensional resonance. In the case where notches are a break in the magnetic core material, the notches can be air, potting material, rubber, plastic, or any material with a permeability and/or permittivity that is low relative to that of the magnetic core material (e.g., the product of the notch permeability and permittivity may be less than 20% of that of the magnetic core material). Such a structure can be formed by constructing a single part with notches, or combining pieces of magnetic material to form a core shape. Notches can be designed to reduce the mass of core material without significantly impacting core loss.

In wireless power transfer applications, the transmit or receive coils may be magnetically coupled to a magnetic core, which can provide many benefits including increasing the magnetic coupling factor, providing shielding, and shaping the magnetic field to minimize loss. The benefits of a magnetic core apply to any type of winding but are particularly useful for foil windings because they can be used to reduce or minimize lateral current crowding—the crowding of current near the edges of the conductors due to non-parallel field lines.

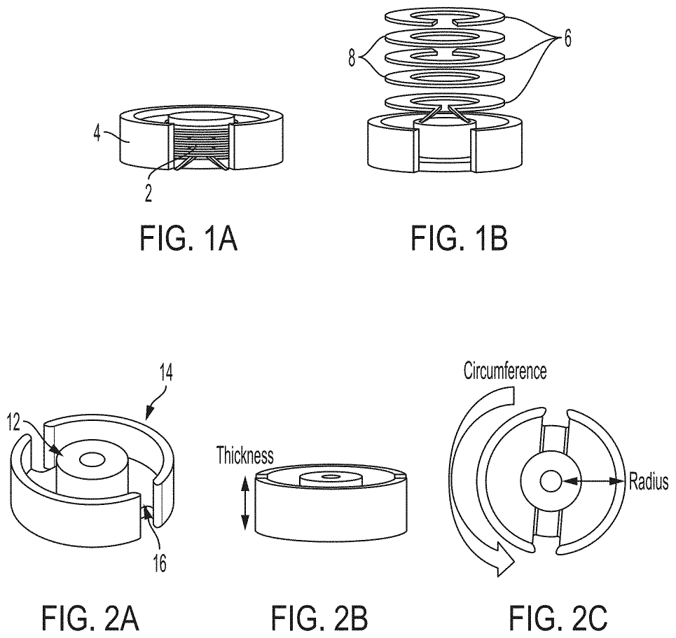

FIG. 1A shows an example of a winding 2 within a magnetic core 4. In particular, FIG. 1A shows an example of a winding including layers of coil conductors in a pot core. FIG. 1B shows an exploded view illustrating the layers of the foil winding, which is a multilayer conductor with integrated capacitor structure having alternating conductors 6 (e.g., which may be thin, foil conductors) separated by respective dielectric layers 8. In some embodiments, the conductors 6 may have gaps at locations that alternate 180 degrees apart (e.g., front, back, front, etc.) in respective conductor layers. However, different types and or number of gaps may be included, and any number of layers may be included. In some embodiments, dielectric layers 8 may be formed of a low-loss material as they serve as the dielectric material of integrated capacitors between respective conductors 6. However, this is one example of a winding with layers of foil, and there are other suitable windings that may include foil, such as foil layers with aligned gaps connected to standalone capacitors, or other designs. Further, the apparatus and techniques described herein are not limited to windings with foil conductors. The conductors of the winding or coil are electrical conductors which may be made of any electrically conductive material or combination of materials, including but not limited to one or more metals such as silver, copper, aluminum, gold and titanium, and non-metallic materials such as graphite. The electrically conductive material may have an electrical conductivity of higher than 200 kS/m optionally higher than 1 MS/m. The electrical conductors may have any physical shape including, but not limited to, solid material, wire, magnet wire, stranded wire, litz wire, foil conductors, conductors laminated on a substrate, printed circuit board traces, integrated circuit traces, or any combination of thereof.

A magnetic core may be, wholly or partially, made of one or more ferromagnetic materials, which have a relative permeability of greater than 1, optionally greater than 10. The magnetic core materials may include, but are not limited to, one or more of iron, various steel alloys, cobalt, ferrites including manganese-zinc (MnZn) and/or nickel-zinc (NiZn) ferrites, nano-granular materials such as Co—Zr—O, and powdered core materials made of powders of ferromagnetic materials mixed with organic or inorganic binders. However, the techniques and devices described herein are not limited as to the particular material of the magnetic core. Further, the magnetic core is not limited to pot cores.

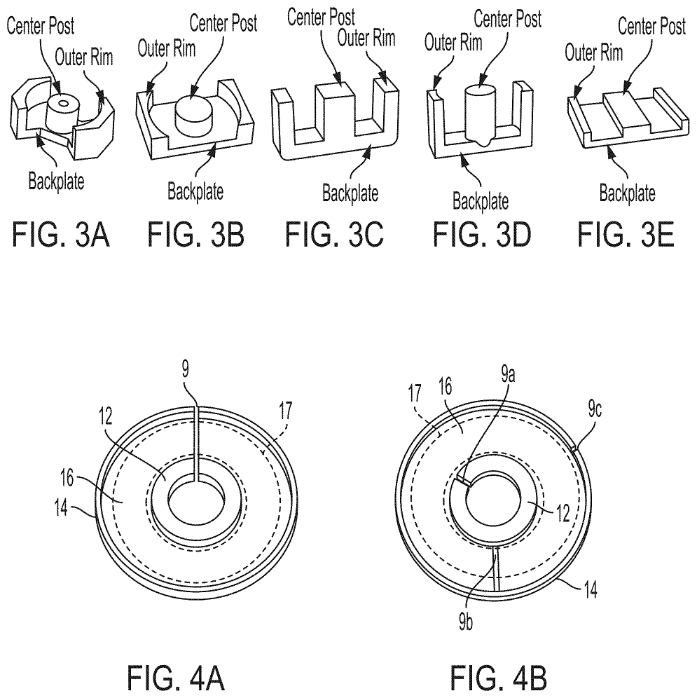

A magnetic core for a wireless power transfer coil may comprise up to three main components, or more, such as: a center post, backplate, and outer rim, for example. The core may be in various shapes, including but not limited to, a pot core or P core, PH core, PM core, PQ core, RM core, E core, EQ core, EH core, EP core, EQ core and planar E core. FIGS. 2 and 3 illustrate the features—center post, backplate and outer rim—in some of these various core shapes. FIGS. 2A-2C show three views of a pot core illustrating the center post 12, backplate 16 and outer rim 14, as well as the thickness, circumference and radius directions of the pot core. FIGS. 3A-3E show various magnetic core shapes with the center post, backplate and outer rim labeled. FIG. 3A shows an RM core. FIG. 3B shows an EQ core. FIG. 3C shows an E core. FIG. 3D shows an EH core. FIG. 3E shows a planar E core. The techniques and apparatus described herein are not limited to the type of magnetic core.

It is not necessary for the magnetic core to have all three components: center post, backplate and outer rim. For example, some cores may consist of a center post and backplate, or just a backplate. For foil windings, cores with only the center post, only the outer rim, or only the center post and the outer rim may especially be useful for minimizing loss while keeping a minimal mass, though such cores are not limited for use with foil windings. A core may have a hole or opening in the middle, in particular in the center post, to reduce mass. Alternatively or additionally, a core may have a hole in one of the backplate or outer rim so that the wire leads can exit the core. A useful single notch embodiment includes a notch in the outer rim and backplate, but not the center post. For completeness, one or more notches in any one or more core features (e.g., outer rim, backplate, or center post) is an embodiment of the present disclosure. A single notch in the center post, backplate and/and outer rim may be enough to reduce or eliminate dimensional resonance.

In some embodiments, dimensional resonance may produce significant losses when the size of a core component exceeds either 1) the skin depth of the magnetic core component

$$\sqrt{\frac{ρ}{π f μ}} ,$$

or 2) the quarter wavelength

$$\frac{1}{4 f \sqrt{μɛ}}$$

of the magnetic core component, where f is the frequency of operation, ρ is the electrical conductivity, μ is the magnetic permeability of the core and ε is the permittivity of the core. A magnetic core component when the characteristic length of the core component exceeds a percentage (e.g., 10%, 30%, 50%, 70%, or 90%) of either the skin depth or the quarter wavelength may benefit from one or more notches are described herein. The characteristic length for a core component is the extent (width, height, radius or circumference, for example) of the core component in a direction perpendicular to the direction in which the magnetic field lines extend. For the center post, the magnetic field lines are mostly in the thickness direction, so the characteristic length can be either the diameter of the center post, or the circumference of the center post. For the backplate, the magnetic field lines are mostly radial, and the characteristic length is either the thickness of the backplate, or the circumference of the backplate. For the outer rim, the magnetic field lines are mostly in the thickness direction, and the characteristic length is either the radial thickness of the outer rim, or the circumference of the outer rim.

The notches can be straight, as illustrated, or may have any other shape such as a zig-zag shape or a curved shape. As shown in FIG. 4A, when notches are formed in two or more of the center post 12, backplate 16 and outer rim 14 the notches may be aligned so that there is a single notch 9 extending radially from the center of the core. Alternatively, one or more of the notches 9a, 9b, and 9c in individual core components may be circumferentially offset with respect to one another, as illustrated in FIG. 4B, which may increase the mechanical strength of the structure. For example, in FIG. 4B the notch 9a in the center post 12 is 120 degrees offset from the notch 9b in the backplate 16, which is also 120 degrees offset from the notch 9c in the outer rim 14. This is merely by way of example, as the offset may be any angle. The size of the notch can vary from application to application. In some embodiments, the size of the notches in the outer rim and center post are minimized to reduce lateral current crowding in the winding. The backplate may have excessive core material, so there can be larger notches and/or more notches in the backplate, which reduces volume and mass without significantly impacting performance. Notches may be increasingly important for reducing volume/mass of the core the farther the notches are from the center of a core (e.g., a pot core) because the effective core area typically increases with increasing distance from the center. FIGS. 4A and 4B also illustrate an outline of the location of the winding 17, which may be above the backplate 16 between the center post 12 and the outer rim 14.

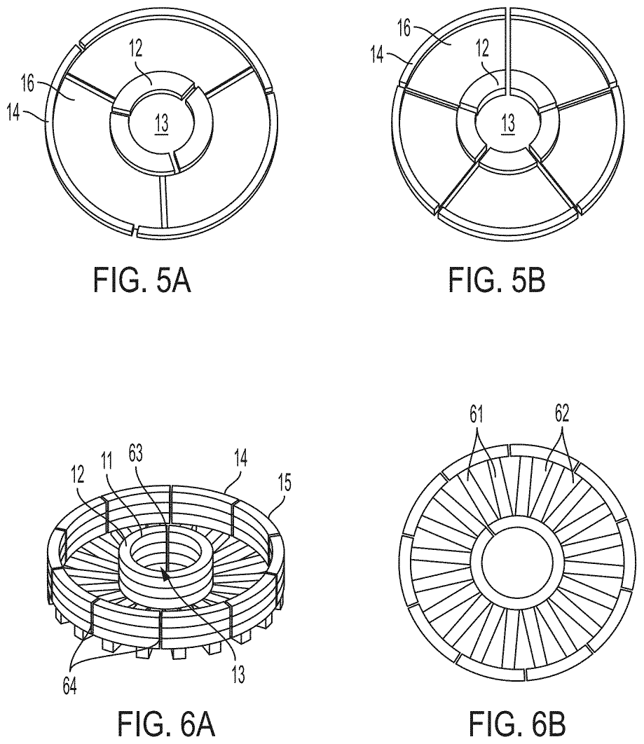

A plurality of notches in any or all core components (e.g., outer rim 14, backplate 16, or center post 12) may be desirable for some cores, particularly larger cores. FIG. 5A illustrates a pot core with three unaligned notches in the center post 12, backplate 16, and outer rim 14. This core can be machined or pressed from a single piece of magnetic material. FIG. 5B illustrates a pot core with five aligned notches. The structure of FIG. 5B can be constructed from pieces of magnetic material placed near each other to form a pot core. Although the examples of FIGS. 5A and 5B show a hole 13 in the center post 12, the center post 12 need not have a hole. For example, if there is no hole 13 and the center post material extends to the center, the center post 12 may have notches extending to the center, creating a plurality of pie-shaped or wedge-shaped center post components.

Multi-notch embodiments also include multiple notches in any core component, and one or more notches in any of the other core components. The number of notches may be different in the different core components. Any of the core components may have a single notch and one or more other components may have plurality of notches. For example, a core may have one notch in the center post and a plurality of notches in the backplate and outer rim. Alternatively, another core component may have a single notch.

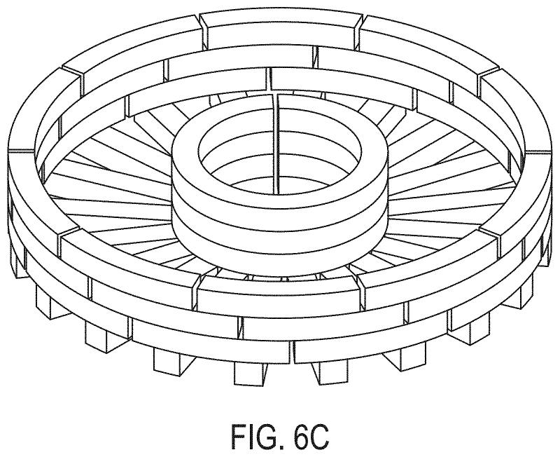

Some embodiments that have multiple notches in the backplate can be improved by having the notches be in the shape of the wedge which forms a “wagon wheel” design. An example of such a design is shown in FIGS. 6A and 6B, which show a perspective view and a top view, respectively, of a magnetic core having a wagon wheel design. As can be seen most clearly in FIG. 6B, the backplate is formed by spokes (members) 61 extending radially between the center post and the outer rim, with the ends of the spokes being underneath the center post and outer rim. In this example the spokes 61 have a rectangular cross-section, though other cross-sectional shapes may be employed. Wedge-shaped notches 62 are present between the spokes 61. The notches 62 have increasing width in the circumferential direction with increased distance from the center. In this example, the spokes 61 have a constant cross-section as they extend radially, which reduces excessive core material. The notches 62 may be free of magnetic core material, and thus the weight and volume of magnetic core material may be reduced.

Because the flux area increases radially in the backplate, without the notches 62 there is excessive core material in the backplate as it expands radially towards the outer rim of the core. Accordingly, the absence of core material in the notches 62 does not have a significant effect on performance. In the embodiment of FIGS. 6A and 6B there is also a notch in the center post 12 and notches in the outer rim. The center post may be formed by stacking a plurality of ring-shaped pieces of core material 11, with a notch 63 extending all the way through the thickness of the center post 12, through all the ring-shaped pieces of core material 11. The ring-shaped pieces of core material 11 may have a rectangular cross-section, as illustrated in FIGS. 6A and 6B, or another suitable cross-section. Also shown is a hole 13 in the center post 12 at the interior of the ring-shaped pieces of core material 11. The outer rim 14 is formed by stacking a plurality of arc-shaped pieces of core material 15, with notches 64 extending all the way through the thickness of the outer rim 14. In other embodiments, the outer rim may be formed by straight pieces of core material, approximating a circle. In the example of FIG. 6A, straight outer rim pieces would result in a decagonal outer rim. The pieces of core material 15 may have a rectangular cross-section, as illustrated in FIGS. 6A and 6B or another suitable cross-section. In the example of FIGS. 6A and 6B the notches 63 in each stacked piece of core material forming the center post are aligned, forming a notch 63 in the center post and notches in the outer rim extending all the way through the thicknesses of the center post 12 and outer rim 14, respectively. However, a notch does not need to extend all the way through the center post 12 or outer rim 14, as in other embodiments the notches may be angularly staggered in successive layers of core material. For example, the notches in the bottom layer of core material of the center post 12 (or outer rim 14) may be at first angular locations, the notches in the middle layer of core material in the center post 12 (or outer rim 14) may be at second angular locations, and the notches in the top layer of core material in the center post 12 (or outer rim 14) may be at third angular locations, with the first, second and/or third angular locations being offset from one another. For example, FIG. 6C shows a perspective view of a core having a wagon wheel design where the notches in the outer rim are at different angular locations in different layers of core material. Offsetting the notches angularly with respect to one another may improve mechanical rigidity of the magnetic core. Regardless of the locations of the notches, a coil or winding may be disposed in the magnetic core in the cavity between the center post and the outer rim. Any suitable coil or winding may be disposed in the cavity, such as any of the coils or windings described herein.

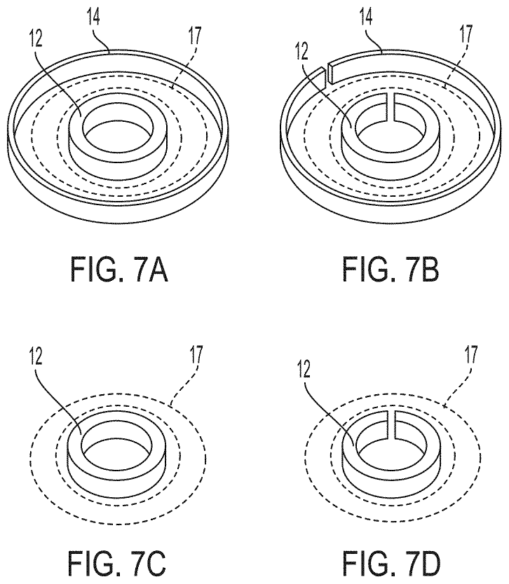

In some applications, for example applications where reduced mass is desired, some embodiments with only the center post 12 and the outer rim 14, but without any backplate 16, may be beneficial. For example, high-Q resonators made of thin conductor layers, such as those shown in FIGS. 1A and 1B, may include core material at the edges of the conductor layers in order to provide straight magnetic field lines in the region of the conductor layers so that a low power loss in the conductor layers can be achieved. The inventors recognize that the backplate may be unnecessary for achieving a high performance while contributing a significant mass, and so the backplate may be eliminated without significant decrease in performance. Eliminating the backplate also provides more space for the conductor layers for a fixed total coil height, which may provide lower power losses in the conductor layers. An example of a magnetic core including a center post 12 and outer rim 14 with no backplate 16 is shown in FIG. 7A. No notches are illustrated in the center post 12 or outer rim 14 in FIG. 7A. However, the inventors recognize that notches of any shape, size and quantity, such as those shown in FIGS. 4-5, may be formed in cores without a backplate in order to mitigate power losses in the cores due to dimensional resonance. An example of a magnetic core with a center post 12 with a notch and an outer rim 14 with a notch offset in angular position from the notch of the center post 12 is shown in FIG. 7B, which is similar to the structure of FIG. 4B but without the backplate 16. The example of FIG. 7B may be modified to include aligned notches and/or different numbers of notches, in other embodiments. Both FIGS. 7A and 7B show a center post 12 with a hole in the middle of the center post but other embodiments may have no hole in the middle of the center post.

The inventors recognize that in some other applications, the elimination of the outer rim, in addition to the elimination of the backplate, may be useful. The inventors recognize that the resulting shape may be used as a center post, around which a winding 17 may be placed around the center post 12 with approximate concentricity to the center post (e.g., the center of the conductor and the center of the center post is offset by less than the radius of the center post). Furthermore, the inventors recognize the value of this structure in a wireless power transfer system. This structure may provide structural rigidity and a significant reduction of mass without a significant decrease in performance. FIG. 7C shows an example of a magnetic core having a center post 12 and no backplate or outer rim. FIG. 7D shows an example of a magnetic core having a center post 12 with a notch and no backplate 16 or outer rim 14. Both FIGS. 7C and 7D show a center post 14 with a hole in the middle of the center post but other embodiments may have no opening in the middle of the center post. The embodiment of FIG. 7D may be modified to include additional notches, and may include a hole in the middle of the center post or no opening in the middle of the center post.

Various aspects of the apparatus and techniques described herein may be used alone, in combination, or in a variety of arrangements not specifically discussed in the embodiments described in the foregoing description and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “substantially,” “approximately,” “about” and the like refer to a parameter being within 10%, optionally less than 5% of its stated value.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. An apparatus, comprising:
a magnetic core, comprising:
a center post;
an outer rim; and
a backplate, having:
a plurality of magnetic material members extending between the center post and the outer rim; and
a plurality of wedge-shaped notches having a width that increases with increased distance from the center post.

2. The apparatus of claim 1, wherein the center post has at least one notch.

3. The apparatus of claim 1, wherein the outer rim has at least one notch.

4. The apparatus of claim 1, wherein the center post comprises a plurality of stacked pieces of magnetic material.

5. The apparatus of claim 1, wherein the outer rim comprises a plurality of stacked pieces of magnetic material.

6. The apparatus of claim 2, wherein the center post has the at least one notch extending through an entire thickness of the center post.

7. The apparatus of claim 3, wherein the outer rim has the at least one notch extending through an entire thickness of the outer rim.

8. The apparatus of claim 1, wherein the center post comprises a plurality of stacked pieces of magnetic material, and/or the outer rim comprises a plurality of stacked pieces of magnetic material, wherein notches in the plurality of stacked pieces of magnetic material of the center post and/or outer rim are at different angular locations in different levels of magnetic material.

9. (canceled)

10. The apparatus of claim 1, further comprising a winding between the center post and the outer rim.

11. The apparatus of claim 10, wherein the winding comprises a plurality of layers of foil conductors.

12. An apparatus, comprising:
a magnetic core, comprising:
one or more of A, B and/or C:
A) a center post having at least one notch, termed at least one first notch;
B) an outer rim having at least one notch, termed at least one second notch; and/or
C) a backplate having at least one notch, termed at least one third notch,
wherein the at least one first notch, the at least one second notch and/or the at least one third notch is wedge-shaped.

13. The apparatus of claim 12, comprising only A, only B, only C, two of A, B and C, or all of A, B and C.

14. The apparatus of claim 12, wherein the magnetic core comprises A and the at least one first notch extends entirely through a thickness of the center post, the magnetic core comprises B and the at least one second notch extends entirely through a thickness of the outer rim and/or the magnetic core comprises C and the at least one third notch extends entirely through a thickness of the backplate.

15. The apparatus of claim 12, wherein the at least one first, second and/or third notch, comprises a plurality of segments at different circumferential positions, each of the plurality of segments extending partially through a core component, wherein the core component is the center post, outer rim or backplate.

16. The apparatus of claim 12, wherein the at least one first notch is circumferentially aligned with or offset with respect to the at least one second notch and/or the at least one third notch.

17. The apparatus of claim 12, wherein the center post, outer rim and/or backplate individually is a core component formed of a plurality of pieces of magnetic material.

18. The apparatus of claim 17, wherein each of the plurality of pieces of magnetic material for a core component has a same shape or a different shape, wherein the core component is the center post, outer rim or backplate.

19. The apparatus of claim 12, wherein the at least one first, second and/or third notch is formed by a volume of reduced magnetic permeability and/or permittivity with respect to an adjacent region of the center post, outer rim and/or backplate or the at least one first, second and/or third notch is formed by an interface between a plurality of pieces of magnetic material brought into contact with one another.

20. The apparatus of claim 12, wherein the at least one third notch comprises a plurality of third notches individually having a wedge shape that is wider with increasing distance from a center of the magnetic core.

21. The apparatus of claim 12, further comprising a winding magnetically coupled to the magnetic core.

22.-43. (canceled)
